(19) United States
(12) Patent Application Publication
(10) Pub. No.: US 2024/0118310 A1
(43) Pub. Date: Apr. 11, 2024

(54) DEVICE FOR MEASURING AND/OR MODIFYING A SURFACE

(71) Applicants: PARIS SCIENCES ET LETTRES, Paris (FR); CENTRE NATIONAL DE LA RECHERCHE SCIENTIFIQUE (CNRS), Paris (FR); SORBONNE UNIVERSITE, Paris (FR); UNIVERSITE DE PARIS, Paris (FR)

(72) Inventors: Antoine Niguès, Paris (FR); Alessandro Siria, Paris (FR); Lydéric Bocquet, Paris (FR)

(21) Appl. No.: 18/273,252

(22) PCT Filed: Jan. 20, 2022
(86) PCT No.: PCT/FR2022/050112

§ 371 Date: Jul. 19, 2023

(30) Foreign Application Priority Data
Jan. 20, 2021 (FR) FR2100549

(51) Int. Cl. G01Q 60/04; G01Q 20/00; G01Q 30/14; G01Q 40/00; G01Q 60/16; G01Q 60/38

(52) U.S. Cl. CPC G01Q 60/04; G01Q 20/00; G01Q 30/14; G01Q 40/00; G01Q 60/16; G01Q 60/38

(57) ABSTRACT

The present invention relates to a device for measuring and/or modifying a surface of a sample, including a sample holder, including a first area configured to receive the sample fixedly mounted relative to the first area, a support, a first probe configured to detect a first parameter at a point of the surface and to generate a first measurement signal representative of the first parameter, and a second probe configured to detect a second parameter at a point of the surface, and to generate a second measurement signal representative of the second parameter, the first parameter being different from the second parameter, or one of the first probe and the second probe being configured to modify a third parameter of the surface at the point of the surface.

### CROSS-REFERENCE TO RELATED APPLICATIONS

This application is a U.S. National Stage Application of PCT/FR2022/050112 filed on Jan. 20, 2022, which claims priority to French Application No. 2100549 filed on Jan. 20, 2021. The entire contents of these applications are incorporated herein by reference in their entirety.

### FIELD OF THE INVENTION

The present invention relates to a device configured to measure and/or process a surface by scanning one or more probes.

### STATE OF THE ART

The atomic force microscope (AFM) allows to measure the topography of a surface with a resolution of the order of a nanometer. In known manner, an AFM comprises a probe, the probe comprising a tip configured to be positioned opposite the surface, for example in contact and up to several hundred nanometers from the surface. The interaction between the tip and the surface to be evaluated leads to a variation of the mechanical properties of the probe. This variation is recorded to evaluate the surface, for example by measuring variations in the reflection of a laser beam on the probe, or variations in the electrical properties of a piezoresistive material integrated into the probe.

Many methods have been developed to evaluate the surface properties from the probe. Among them, the best known are, for example, measurement in contact, non-contact, intermittent contact or frequency or amplitude modulation mode. The intermittent contact mode consists for example in vibrating the probe at its resonant frequency, at a predetermined amplitude. The interaction between the tip of the probe and the surface causes a variation in the resonance frequency of the probe, and thus a reduction in the amplitude of the vibrations. Various servo-control means allow to maintain the amplitude of the vibrations of the probe constant, or the amplitude of the forces of interaction between the tip and the surface constant, while scanning the surface with the tip so as to evaluate the surface.

When using an AFM microscope, the spatial resolution, in a plane tangent to the surface, is limited by the dimension of the tip. On the other hand, the resolution of an interaction force measurement between the tip and the surface is limited by the mechanical properties of the probe.

In known manner, an AFM probe has a tuning fork shape, of micrometric or millimetric size, made for example of quartz. Giessibl and al. (Giessibl, F. J., Pielmeier, F., Eguchi, T., An, T., & Hasegawa, Y. (2011), Comparison of force sensors for atomic force microscopy based on quartz tuning forks and length-extensionaL resonators, Physical Review B, 84(12), 125409) describe the use of a micrometric probe, having a bending stiffness comprised between 500 N·m⁻¹ and 3000 N·m⁻¹.

Stowe and al. (Stowe, T. D., Yasumura, K., Kenny, T. W., Botkin, D., Wago, K., & Rugar, D., 1997, Attonewton force detection using ultrathin silicon cantilevers, Applied Physics Letters, 71(2), 288-290) describe the minimum force Fₘᵢₙ that can be measured by a beam-shaped probe by the formula (1):

$${F}_{min} = \sqrt{\frac{{wt}^{2}}{lQ}} {( E ρ )}^{( 1 / 4 )} {( {k}_{B} TB )}^{( 1 / 2 )}$$

where w is the beam width, t is the beam thickness, l is the beam length, Q is the beam quality factor, k_{B} is Boltzmann constant, T is the temperature and B is the width of the detection bandwidth. Formula (1) directly encourages the person skilled in the art to develop the lightest and most flexible probe possible so as to reduce the detection threshold of the AFM microscope.

However, such probes have the following drawbacks: they are both expensive and fragile. It is common to have to replace the probe of an AFM microscope more than twice when measuring the topography of a surface.

To this end, Canale and aL. (Canale, L., Laborieux, A., Mogane, A. A., Jubin, L., Comtet, J., Lainé, A., Bocquet, L., Siria, A. & Nigués, A., 2018, MicroMegascope. Nanotechnology, 29(35), 355501) describe an atomic force microscope comprising a macroscopic probe. The probe comprises a harmonic oscillator of macroscopic size, in particular a tuning fork whose size is greater than 1 cm, on which a tungsten tip is fixedly mounted and intended to be positioned facing the surface to be evaluated. Thus, due to the dimensions of the tuning fork, it is possible to modify the type of tip without modifying the entire structure of the probe. It is also possible to use less expensive probes. In addition, the mass of the probe is higher than that of prior art probes by several orders of magnitude. Thus, the coupling of the probe with macroscopic elements configured to measure the position of the probe does not substantially modify the mechanical properties of the probe, and the detection performance of the AFM microscope is not deteriorated.

However, the evaluation of a surface in contact with an element other than air, for example a vacuum or a liquid medium, can prove to be complex. Indeed, the probe must be at least partly introduced into this medium, which increases the complexity of the design of the microscope and/or leads to surface measurement biases.

In addition, the known devices do not allow to easily measure different parameters at the same point of the surface, nor to process the surface while measuring it, using different probes. Such multiple measurements or processing operations are difficult and costly today, and require the use of different instruments, with limited results.

Document FR 3089850 describes an additive manufacturing system for depositing a fluid on a substrate in a controlled manner. The system allows to detect the approach of a protuberance in the vicinity of the substrate, but does not allow to implement a simultaneous measurement with the deposition, allowing to characterize the deposits made.

The document Ponomareva and al. (Ponomareva, S., Zanini, L. F., Dumas-Bouchiat, F., Dempsey, N. M., Givord, D., & Marchi, F. (2014). Measuring the force gradient acting on a magnetic microsphere above a micro-magnet array, in Advanced Materials Research, Vol. 872, pp. 167-173, Trans Tech Publications Ltd) describes a method in which a surface is imaged with an atomic force microscope, and in which the same surface is imaged with another atomic force microscope whose tip is functionalized so as to detect the magnetic properties of the surface. However, this type of measurement is complex to implement because it requires the user to find the exact part of the substrate that he wishes to image in two different ways. Indeed, the probes allowing to measure the surface in AFM mode, or in functionalized AFM mode so as to detect magnetic properties of the surface, each comprise a probe movement detector. It is thus necessary to change the device to implement each of the measurements.

### DISCLOSURE OF THE INVENTION

An object of the invention is to propose a solution for manufacturing a device allowing to couple measurements of different natures using a device that is simpler than the known devices. Another object of the invention is to increase the precision of the measurements obtained by the known devices. Another object of the invention is to propose a solution allowing both to measure a surface and to process or modify the measured surface. Another object of the invention is to allow to measure the same surface by a tunneling current measurement and by an atomic force measurement.

At least one of the above purposes is achieved in the context of the present invention by means of a device for measuring and/or modifying a surface of a sample, comprising:
a sample holder, comprising a first area configured to receive the sample fixedly mounted relative to the first area,
   a support, the device also comprising at least one element selected from:
      i) a hybrid probe configured to detect a first parameter at a point of the surface and to generate a first measurement signal representative of the first parameter, and a second parameter at the same point of the surface, different from the first parameter, and to generate a second measurement signal representative of the second parameter, and
      ii) a first probe configured to detect a first parameter at a point of the surface and to generate a first measurement signal representative of the first parameter, and a second probe configured to detect a second parameter at a point of the surface and to generate a second measurement signal representative of the second parameter,
      the first parameter being different from the second parameter, or one of the first probe and the second probe being configured to modify a third parameter of the surface at the point of the surface,
the sample holder comprising at least a second area, distinct from the first area and fixed relative to the support, the sample holder being deformable so as to allow relative displacement of the first area relative to the second area,
the device comprising a detector configured to detect a displacement of the first area relative to the second area,
the device comprising a processing module configured to determine a property of the surface at a plurality of points of the surface from a plurality of first signals and from a plurality of second signals generated by the hybrid probe, or by the first probe and by the second probe, when the hybrid probe is positioned successively facing several points of the surface, or when the first probe and the second probe are each positioned successively facing several points of the surface.

The device can advantageously comprise the following features, taken individually or in any of their technically possible combinations:
the first probe and the second probe are each configured to modify respectively a third parameter of the surface and a fourth parameter of the surface at the point of the surface, the third parameter and the fourth parameter being different from each other,
the device comprises the first probe and the second probe, the device also comprising a probe switch, the first probe and the second probe each being fixedly mounted on the probe switch, the switch being configured to cause movement of the first probe and the second probe relative to the sample holder, so that before the movement, the first probe is facing a point of the surface and after the movement, the second probe is facing the same point of the surface,
the switch comprises a system for rotating the probes configured so that the movement is a rotational movement, the switch preferably comprising a translation system configured to control a translation of the rotation system, relative to the sample holder along an axis perpendicular to the surface,
the switch comprises a translation system configured to control a translation of the rotation system relative to the sample holder along an axis parallel to the surface,
the sample holder is a harmonic oscillator,
the detector is mounted fixed to the sample holder, and is preferably mounted fixed to the first area,
the device comprises an actuator configured to vibrate the sample holder at a predetermined frequency,
the device comprises a closed-loop servo-control regulator, the detector being configured to transmit a signal representative of a measurement of the displacement of the first area to the regulator and the regulator being configured to transmit a regulation signal to the actuator,
the sample holder has a length greater than 2 mm, in particular greater than 1 cm, and preferably greater than 3 cm,
a bending stiffness of the sample holder between the first area and the second area is greater than 10³ N·m⁻¹, in particular greater than 104 N·m⁻¹ and preferably greater than 10⁵ N·m⁻¹,
the device comprises a cell configured to contain a liquid medium, the cell being preferably mounted fixed relative to the first area, and the sample being mounted fixed to the cell,
the sample holder comprises several second areas, and preferably in which the first area is arranged between two second areas and at an equal distance from each of the second areas.

Another object of the invention is a method for evaluating a surface of a sample by a device which is the object of the invention, the device comprising the first probe and the second probe and the processing module configured to determine a property of the surface at a plurality of points of the surface from a plurality of first signals generated by the first probe and a plurality of second signals generated by the second probe when the first probe and the second probe are each positioned successively facing several points of the surface, the method comprising steps of:
a) positioning the first probe facing a point of the surface, preferably at a distance less than 100 nm from the point of the surface and in particular less than 10 nm from the point of the surface,
b) measuring the displacement of the first area relative to the second area by the detector so as to evaluate an interaction between the surface and the first probe,
c) positioning the second probe facing the point of the surface, preferably at a distance less than 100 nm from the point of the surface and in particular less than 10 nm from the point of the surface, and preferably
d) measuring the displacement of the first area relative to the second area by the detector so as to evaluate an interaction between the surface and the second probe.

Advantageously, one of the first probe and the second probe is configured to modify a third parameter of the surface at the point of the surface, the method comprising a step, subsequent to step b) and/or to step d), of modifying the third parameter of the surface at the point of the surface.

Advantageously, a repetition of step a) defines a scanning of the surface by the first probe and, preferably, a repetition of step c) defines the same scanning of the surface by the second probe.

Advantageously, the method comprises steps of:
determining a first image of the surface from a repetition of step b), each step b) being subsequent to a step a) of the repetition of steps a),
determining a second image of the surface from a repetition of step d), each step d) being subsequent to a step c) of the repetition of steps c), and preferably a step of
determining a third image of the surface from the first image and the second image.

Advantageously, the method also comprises a step e) of actuating the sample holder, concomitant with the measurement step b) and/or with the measurement step d), in which the actuator is actuated so as to vibrate the first area of the sample holder at a predetermined frequency comprised between 500 Hz and 10 MHz, and preferably, the sample holder has at least one natural resonance frequency fₖ, so as to vibrate the first area at a frequency comprised between (fₖ−0.5.fₖ) and (fₖ+0.5.fₖ).

Advantageously, the actuator is actuated so as to vibrate the first area of the sample holder at several predetermined frequencies.

Another object of the invention is a method for determining a spatial parameter for calibrating a device for measuring and/or modifying a surface of a sample, the device being a device according to an embodiment of the invention, comprising the first probe, the second probe and a processing module configured to determine a property of the surface at a plurality of points of the surface from a plurality of first signals generated by the first probe and a plurality of second signals generated by the second probe when the first probe and the second probe are each positioned successively facing several points of the surface, the method comprising steps of:
e) positioning the first probe facing a first point of the surface,
f) measuring the displacement of the first area relative to the second area by the detector so as to evaluate an interaction between the surface and the first probe,
g) positioning the second probe facing a second point of the surface,
h) measuring the displacement of the first area relative to the second area by the detector so as to evaluate an interaction between the surface and the second probe,
the method comprising:
   determining a first calibration image of the surface from a repetition of steps e) and f), each step e) being implemented facing different first points of the surface,
   determining a second calibration image of the surface from a repetition of steps g) and h), each step g) being implemented facing different second points of the surface,
   determining the spatial calibration parameter from a spatial offset between the first calibration image and the second calibration image.

### DESCRIPTION OF THE FIGURES

Other features, objects and advantages of the invention will emerge from the description which follows, which is purely illustrative and non-limiting, and which must be read in conjunction with the appended drawings in which:

FIG. 1 schematically illustrates a device according to one embodiment of the invention,

FIG. 2 is a photograph of a device according to one embodiment of the invention,

FIG. 3 schematically illustrates a part of a device according to one embodiment of the invention configured to evaluate the surface of a sample in a liquid medium,

FIG. 4 schematically illustrates a probe switch according to one embodiment of the invention,

FIG. 5 schematically illustrates a probe switch according to one embodiment of the invention,

FIG. 6 schematically illustrates a probe switch according to one embodiment of the invention,

FIG. 7 schematically illustrates a method for evaluating and/or modifying a surface according to one embodiment of the invention,

FIG. 8 illustrates a method for determining a calibration spatial parameter according to one embodiment of the invention,

FIG. 9 illustrates a mechanical response of a harmonic oscillator according to one embodiment of the invention,

FIG. 10 illustrates a tunneling measurement according to one embodiment of the invention,

FIG. 11 is an image of an atomic step produced by a device according to one embodiment of the invention by tunneling imaging,

FIG. 12 is an image of an atomic step produced by a device according to one embodiment of the invention by tunneling imaging,

FIG. 13 is a profile of an atomic step produced by a device according to one embodiment of the invention by tunneling imaging,

FIG. 14 is a profile of an atomic step produced by a device according to one embodiment of the invention by tunneling imaging,

FIG. 15 is an image of an atomic step produced by a device according to one embodiment of the invention by atomic force imaging,

FIG. 16 is an image of an atomic step produced by a device according to one embodiment of the invention by tunneling,

FIG. 17 is a profile of an atomic step produced by a device according to one embodiment of the invention by atomic force imaging,

FIG. 18 is a profile of an atomic step produced by a device according to one embodiment of the invention by tunneling.

In all the figures, similar elements bear identical references.

### DETAILED DESCRIPTION OF THE INVENTION

### General Architecture of the Device 1

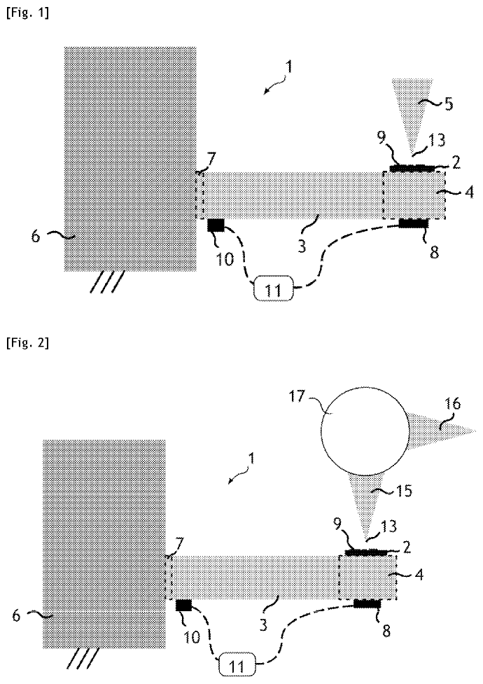

With reference to FIG. 1 and FIG. 2, the device 1 comprises a sample holder 3. The sample holder 3 supports a sample 2 comprising a surface 9 configured to be measured. In particular, the sample holder 3 comprises at least two distinct areas: a first area 4 and a second area 7. The first area 4 is configured to receive the sample 2 fixedly mounted relative to the first area 4. The device 1 also comprises a support 6. The support 6 is mounted fixed to the ground or to the reference of the place of measurement. The second area 7 is mounted fixed to the support. The second area 7 can form a single piece with the support 6, or be welded to the support 6.

The sample holder 3 is deformable, so as to allow relative displacement of the first area 4 relative to the second area 7. Preferably, the bending stiffness of the sample holder 3, and in particular of the part(s) located between the first area 4 and the second area(s) 7, has a bending stiffness greater than 10³ N·m⁻¹, in particular greater than 104 N·m⁻¹ and more preferably greater than 10⁵ N·m⁻¹. In addition, the bending stiffness of the sample holder 3, and in particular of the part(s) located between the first area 4 and the second area(s) 7, has a bending stiffness of less than 108 Nm⁻¹, and preferably less than 10⁷ Nm⁻¹. The sample holder 3 can for example be made of aluminum. Thus, even though the sample holder 3 is deformable, it can have a higher rigidity than that of the probes of the prior art while remaining deformable enough to allow an evaluation of the surface.

The sample holder 3 has at least one macroscopic dimension, that is to say greater than 2 mm, in particular greater than 1 cm, and preferably greater than 3 cm. The sample holder 3 may for example be in the shape of a cuboid aluminum bar, 7 cm long, 12 mm thick and 7 mm wide. The first area 4 then corresponds to one of the ends of the bar, and the second area 7 corresponds to the other end of the bar, mounted fixed to the support. At least, the dimensions of the sample holder 3 must allow the sample holder 3 to support the sample 2.

The sample holder 3 is preferably a harmonic oscillator. The sample holder 3 can have a natural frequency comprised between 500 Hz and 10 MHz, preferably comprised between 1 kHz and 1 MHz. Thus, the measurement of the frequency of the sample holder 3 is not disturbed by surrounding noise, for example caused by electrical or acoustic noise. The sample holder 3 has for example a quality factor greater than 10, and preferably greater than 100. For example, the sample holder 3 has a natural frequency of 2 kHz, and a quality factor of 100.

The sample holder 3 can also be in the shape of a tuning fork of macroscopic size, preferably with a length greater than 1 cm. The stem of the tuning fork corresponds to the second area 7, and at least one blade of the tuning fork corresponds to the first area 4. Thus, the quality factor of the sample holder 3 can be maximized compared to a beam-shaped sample holder 3 of the same length.

The device 1 also comprises a detector 8 configured to detect a displacement of the first area 4 relative to the second area 7. The second area 7 being fixed relative to the ground, it may be sufficient for the detector 8 to detect the absolute movement of the first area 4. The detector 8 can be an accelerometer, for example manufactured using MEMS technology, fixedly mounted relative to a part of the sample holder 3 and preferably relative to the first area 4 of the sample holder 3. Thus, it is possible to maximize the measured movement amplitude of the sample holder 3. Alternatively or in addition, the detector 8 can be an optical interferometer, a capacitive detector, a piezoelectric detector, a laser deflection detector, and/or a tunnel effect detector. With reference to FIG. 2, the detector 8 is for example mounted fixed facing the sample 2 on the first area 4 of the sample holder 3. The frequency range of movement detectable by the detector 8 must comprise the natural frequency of the sample holder 3. The detector 8 can advantageously measure movements corresponding to vibrations of very low amplitude of the sample holder 3, preferably of an amplitude less than 1 nm, and in particular of an amplitude less than 500 pm. Thus, it is possible to use a sample holder 3 presenting a higher rigidity than the probes of the prior art.

### Probe(s)

The device 1 comprises at least one probe 5.

The term “probe 5” means:
a hybrid probe 14, configured to detect a first parameter at a point of the surface 9 and generating a first measurement signal representative of the first parameter, and a second parameter at the same point of the surface 9, different from the first parameter, and to generate a second measurement signal representative of the second parameter, and/or
a probe, for example a first probe 15 or a second probe 16, configured to detect a parameter at a point of the surface 9 and to generate a measurement signal representative of the first parameter.

A probe 5 is configured to detect a parameter at a point of the surface 9 and to generate a measurement signal representative of the first parameter, and may be configured to modify a parameter of the surface 9 at the point of the surface 9.

In all embodiments of the invention:
the device 1 is configured to generate at least two different signals, each signal being representative of a parameter different from the parameter represented by the other signal, and/or
the device comprises at least two probes 5, one of the two probes 5 being configured to modify a third parameter of the surface 9 at the point of the surface 9. Thus, it is possible to interact with a point of the surface 9 considering a plurality of different or modified surface parameters. This is the case when two different surface parameters are measured at the same point of the surface 9, or when a surface parameter is measured at a point and the same parameter or a parameter different from the measured parameter is modified by a probe.

The device 1 comprises at least one element selected from:
i) a hybrid probe 14 configured to detect a first parameter at a point of the surface 9 and generate a first measurement signal representative of the first parameter, and a second parameter at a point of the surface 9, different from the first parameter, and to generate a second measurement signal representative of the second parameter, and
ii) a first probe 15 configured to detect a first parameter at a point of the surface 9 and generate a first measurement signal representative of the first parameter, and a second probe 16 configured to detect a second parameter at a point of the surface 9 and to generate a second measurement signal representative of the second parameter,
the first parameter being different from the second parameter, or one of the first probe 15 and the second probe 16 being configured to modify a third parameter of the surface 9 at the point of the surface 9.

It should be noted that one of the first probe 15 and the second probe 16 can itself be a hybrid probe.

The probe 5 may comprise a tip 13 configured to be positioned facing the surface 9 of the sample. The device 1 comprises means for positioning the probe 5 relative to the surface 9.

The probe 5 may comprise a tungsten tip etched by electrochemistry, mounted fixed to means for positioning the probe 5 relative to a direction tangential to the surface 9, allowing control of the position with a sub-micrometric precision, preferably less than 100 pm. The means for positioning the probe 5 can comprise a piezoscanner. Differently from the prior art, the probe may not comprise a sensor, and thus be passive.

The probe 5 can be configured to measure one or more parameters representative of the surface 9 and/or to modify the surface 9. Preferably, the probe 5 can be configured to measure a parameter representative of the surface 9 by atomic force measurement (AFM), by current tunneling measurement (STM), by thermal measurement, by magnetic measurement, by chemical measurement.

Preferably, the probe 5 can be configured to process a point of the surface 9, for example by depositing a material from the probe 5 towards the point of the surface 9, and/or by depositing particles from the probe 5 towards the point of the surface 9.

Preferably, the probe 5 may comprise a tungsten tip 13, and/or a gold tip 13, and/or a platinum tip 13, and/or an AFM lever. The probe 5 can also preferably comprise a stretched pipette, configured to suck or deposit a liquid or a gas on the surface 9. Thus, it is possible to deposit ink, a single liquid, and/or salt water on the surface 9. The probe 5 can also preferably comprise a sphere comprising a glass surface, the glass surface being preferably chemically functionalized, for example by gold, by chemical groups specific to making the glass surface hydrophobic, by highly oriented pyrolytic graphite, by graphene comprising boron nitride (BN graphene). The probe 5 can also comprise a microgripper, preferably manufactured by lithography. The probe 5 may also comprise an electrically conductive tip 13, and/or a resistive tip 13 and/or a thermal tip 13 and/or a tip 13 comprising a diamond surface.

Preferably, at least one of the probes 5 is made of a material which is different from another probe 5. Each probe 5 can comprise positioning means independent of each other.

The inventors have discovered that the sample holder 3 can be used to detect the interactions between the surface 9 and the tip 13 of the probe 5. Indeed, the tip 13 can be moved closer to the surface 9 at a sufficiently small distance, for example comprised between 1 Å and 10 cm, preferably between 1 nm and 10 μm, to increase the interaction between the tip 13 and the surface 9, so that the mechanical properties of the sample holder 3 are modified. Thus, unlike atomic force or local probe microscopes of the prior art, in which the sensor is part of or is attached to the probe 5, the interactions between the surface 9 and the tip 13 are detected by the sample holder 13. The sample holder 3 is mechanically decoupled from the probe 5. Thus, it is possible to significantly reduce the cost of a probe 5, since the probe 5 does not necessarily comprise a sensor. Furthermore, the implementation of a plurality of measurements is facilitated because the various probes used all operate with the same sensor. Furthermore, the cost of the device 1 as a whole can also be reduced, the sample holder 3 being reused for each measurement. The evaluation of the surface 9 can be implemented in media other than air in a simplified way: indeed, the manufacture of the sensor no longer has to take into account the dissipation of the energy transmitted to the medium during the movement of the probe 5 in a medium with properties that are different from air such as a liquid, because the movement allowing the detection of the interaction between the tip 13 and the surface 9 is carried out by the sample holder 3. Even if the medium in contact with the surface 9 is not such as to cause more frictional forces with the probe 5 than the air, as is the case for a partial vacuum, the integration of a probe 5 without sensor in an enclosure configured to said medium is simplified. Finally, the hybrid probe 14 and/or the first probe 15 and the second probe 16 being configured to interact with different parameters of the surface, it is possible to measure the surface 9 more precisely and/or to precisely measure the surface 9 and modify it.

The device 1 also comprises a processing module configured to determine a property of the surface at a plurality of points of the surface from a plurality of first signals and a plurality of second signals generated by the hybrid probe, or by the first probe and by the second probe, when the hybrid probe 14 is positioned successively facing several points of the surface 9, or when the first probe 15 and the second probe 16 are each positioned successively facing several points of the surface 9. Thus, it is possible to improve the precision of an evaluation of the surface by successively measuring, on the same surface, two different parameters. It is thus also possible, when one of the probes 5 and/or when the two probes 5 are configured to modify one or more parameters of the surface, to modify and/or successively measure the same part of the surface 9.

Preferably, the first probe 15 and the second probe 16 are each configured to modify respectively a third parameter of the surface 9 and a fourth parameter of the surface 9 at the point of the surface 9, the third parameter and the fourth parameter being different from each other. Thus, it is possible to modify the same part of the surface 9 successively according to several parameters. It is for example possible to implement additive manufacturing on the surface 9 using several materials, each of the materials being deposited by one of the probes 5, the different parameters being for example the content of the surface in each of the materials added and/or the surface thickness and morphology. For example, the first probe deposits a product on the surface and the second probe then deposits a reagent.

A modification of the surface 9 can also include an etching of the surface 9 by a probe 5. In this case, the parameter of the surface 9 can be representative of the morphology of the surface.

A modification of the surface 9 can also comprise a deposition of biological material on the surface 9, and preferably of biological cells. In this case, the modified parameter of the surface 9 can be representative of the cell density on the surface 9.

A modification of the surface 9 can also comprise the deposition of a liquid by a first probe 15 forming a pipette configured to eject the liquid onto the surface 9. In this case, the probe 5 can be configured to measure a parameter of the surface 9 by detecting capillary forces between the pipette forming the first probe 15 and the surface 9. Preferably, a device 1 comprising the first probe 15 can also comprise a second probe 16 configured to measure a parameter of the surface 9 by atomic force, that is to say, for example, to measure repulsive Pauli forces between the second probe 16 and the surface 9.

Preferably, the device 1 can comprise a first probe 15 configured to detect a force caused by the surface on the first probe, preferably of the AFM type, and a second probe 16 configured to detect a parameter of the surface different from a force caused by the surface on the first probe, preferably an electric tunnel current and/or a temperature and/or a chemical composition of the surface.

Preferably, the device 1 can comprise a first probe 15 configured to detect a force caused by the surface on the first probe, preferably an atomic force, and a second probe 16 configured to detect a parameter of the surface different from a force caused by the surface on the first probe, preferably a tunnel electric current and/or a temperature and/or a chemical composition of the surface, one of the first probe 15 and the second probe 16, or a third probe, being configured to modify a parameter of the surface, preferably to deposit a material on the surface or to deposit particles on the surface 9.

Preferably, the device 1 can comprise a first probe 15 configured to detect a force caused by the surface on the first probe 15, preferably an atomic force, and a second probe 16 configured to detect a parameter of the surface different from a force caused by the surface on the first probe 15, preferably a rheology of the surface 9, and/or an electronic property of the surface 9, a magnetic property of the surface 9, a physicochemical property of the surface 9.

Preferably, the device 1 can comprise a first probe 15 configured to detect a tunnel current between the probe 5 and the surface 9, and a second probe 16 configured to detect a parameter of the surface different from a tunnel current between the probe 5 and the surface 9.

### Measurement in Liquid Medium

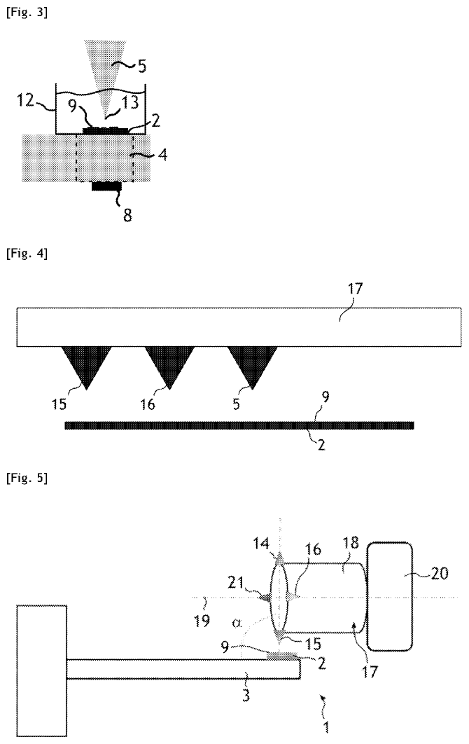

The device 1 is particularly advantageous for implementing measurements of a surface 9 in a liquid medium. With reference to FIG. 3, the device 1 may comprise a cell 12. The cell 12 is configured to contain a liquid or gelled medium.

The cell 12 is mounted fixed to the first area 4. The sample is mounted fixed to the cell 12. By integrating the sensor into the sample holder 3, the measurement of a surface 9 in a liquid medium is simplified. Indeed, it is not necessary for the probe 5, comprising the tip 13, to oscillate. Thus, the measurement is not interfered with by any frictional forces which may be exerted by the liquid medium on the probe 5 during the evaluation of the surface 9, as is the case in the microscopes of the prior art. This type of configuration is particularly advantageous for the evaluation of biological objects attached to the surface 9. In addition, since the detector 8 is not mounted in a submerged probe 5, it is possible to avoid a drift of the outlet signal of the detector 8. Indeed, the sample holder 3 and the detector 8 can be kept out of contact with the liquid medium.

### Switch 17

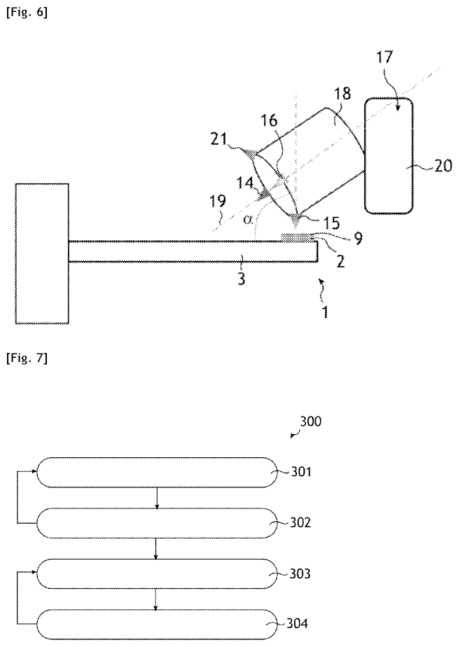

With reference to FIG. 4, FIG. 5 and FIG. 6, the device 1 can comprise a switch 17 of probes, the first probe 15 and the second probe 16 each being fixedly mounted on the switch 17 of probes 5, the switch 17 being configured to cause movement of the first probe 15 and of the second probe 16 so that before the movement, the first probe 15 is facing a point of the surface 9 and that after the movement, the second probe 16 is facing the same point of the surface 9. Thus, it is possible to scan exactly the same surface 9 successively with the first probe 15 and with the second probe 16. This technique allows to measure the surface with increased precision with respect to the devices with which the two parameters of the surface 9 are measured at the same time by two probes.

With reference to FIG. 4, the switch 17 may be a linear switch. The switch 17 can be configured to control a translational movement of part of the switch 17 so as to interchange the position of the first probe 15 of the second probe 16. Preferably, the movement of the switch 17 can be controlled in part by a piezoelectric system. Thus, it is possible to control the position of the probes 5, before the movement of the switch and after the movement of the switch, with a resolution less than or equal to 100 pm.

With reference to FIG. 5 and FIG. 6, the switch 17 preferably comprises a system 18 for rotating the probes 5, configured so that the movement is a rotational movement around a main axis 19. The rotational movement is preferably controlled by a piezoelectric rotor. Thus, it is possible to control the rotation of the rotation system with a precision less than or equal to 1 radian, so as to interchange the position of the first probe and the position of the second probe with precision.

The switch 17 preferably comprises a translation system 20 configured to control a translation of the rotation system 18 along an axis perpendicular to the surface 9. Thus, it is possible to interchange the position of the first probe 15 with the position of the second probe 16 at a distance very close to the surface 9, preferably less than 100 nm, for example by implementing a translational movement so as to move the first probe 15 away from surface 9, a rotational movement so as to interchange the position of the first probe 15 with the position of the second probe 16, and finally a translational movement so as to move the second probe 16 closer to the surface 9.

The switch 17 preferably comprises a translation system configured to control a translation of the rotation system 18 relative to the sample holder 3 along an axis parallel to the surface 9. Thus, it is possible to control with precision, preferably less than 100 nm, the exact position of the point of the surface 9 facing the probe 5.

The probe 5 may have a main axis crossing the tip 13 of the probe 5. Preferably, the main axis of the probe 5 is perpendicular to the surface 9, or locally perpendicular to the plane tangent to the surface 9 at the point facing the probe 5. The direction of the main axis of the rotation system 18 and the direction of the main axis of the probe 5 relative to the main axis of the rotation system 18 are determined so that the main axis of the probe 5 is perpendicular to the surface 9. For example, the main axis of the rotation system 18 can be parallel to the surface 9, and the main axis of the probe 5 can form an angle with the main axis of the rotation system 18 equal to 90°. For example, the main axis of the rotation system 18 can form an angle equal to 450 with the surface 9, and the main axis of the probe 5 can form an angle equal to 450 with the main axis of the rotation system 18.

Method for Measuring and/or Modifying the Surface 9

With reference to FIG. 7, another aspect of the invention is a method 300 for evaluating the surface 9 by the device 1, the device 1 comprising the first probe 15, the second probe 16 and the processing module configured to determine a property of the surface at a plurality of points of the surface from a plurality of first signals generated by the first probe 15 and a plurality of second signals generated by the second probe 16 when the first probe 15 and the second probe 16 are each positioned successively facing several points of the surface 9.

It should be noted that one of the first probe 15 and the second probe 16 can itself be a hybrid probe.

It should also be noted that the method can also be implemented with a hybrid probe instead of the assembly formed by the first probe and the second probe.

The method comprises a step 301 of positioning the first probe 15 facing a point of the surface 9, preferably at a distance less than 100 nm from the point of the surface and in particular less than 10 nm from the point of the surface 9.

The method comprises a step 302 of measuring the displacement of the first area 4 relative to the second area 7 by the detector 8 so as to evaluate an interaction between the surface 9 and the first probe 15.

The method comprises a step 303 of positioning the second probe 16 facing the point of the surface 9, preferably at a distance less than 100 nm from the point of the surface and in particular less than 10 nm from the point of the surface 9.

Preferably, the method comprising a step 304 of measuring the displacement of the first area 4 relative to the second area 7 by the detector 8 so as to evaluate an interaction between the surface 9 and the second probe 16.

The method 300 preferably comprises a repetition of the steps 301 and 302, the step 301 being carried out at other points facing the surface 9. The repetition of the step 301 defines a scanning of the surface 9 by the first probe 15. The repetition can be implemented by scanning the surface 9 to be evaluated by moving the first probe 15. The scanning can be implemented by repeating the steps 301 and 302 at successive points separated for example by a sub-nanometric distance, comprised between 100 μm and 1 nm.

The method 300 preferably comprises a repetition of the steps 303 and 304, the step 303 being carried out at points facing the surface 9 during the repetition of the steps 301 and 302. The repetition of the step 303 defines a scanning of the surface 9 by the second probe 16. The repetition can be implemented by scanning the surface 9 to be evaluated by moving the second probe 16. The scanning can be implemented by repeating steps 303 and 304 at successive points separated by example by a sub-nanometric distance, comprised between 100 μm and 1 nm.

Preferably, one of the first probe 15 and of the second probe 16, or another probe 5 of the device 1, is configured to modify a third parameter of the surface 9 at the point of the surface 9 and the method 300 comprising a step, subsequent to step 302 and/or to step 304, of modifying the third parameter of the surface 9 at the point of the surface 9. Thus, it is possible to precisely control a modification of the surface with regard to an evaluation of the surface 9 preceding this modification.

Preferably, the method 300 also comprises steps of:
determining a first image of the surface 9 from a repetition of step 302, each step 302 being subsequent to a step 301 of the repetition of steps 301, and of
determining a second image of the surface 9 from a repetition of the step 304, each step 304 being subsequent to a step 303 of the repetition of steps 303. Thus, it is possible to compare several images of the same surface obtained by different measurements.

The first probe allows to evaluate an interaction between the surface 9 and the first probe 15 at different points of the surface. An association is thus determined between a point of the surface and a measured parameter. In this sense, it is possible to determine a “first image” of the surface 9 which is a representation of the parameter measured according to the points of the surface.

The expression “second image” is used with the same meaning in relation to the parameter measured using the second probe.

Preferably, the method 300 also comprises a step of determining a third image of the surface 9 from the first image and the second image. Thus, it is possible to obtain a more precise image of the surface 9 by combining the information of the first image of the second image.

### Vibration of the Sample Holder 3

With reference to FIG. 1 and FIG. 2, the device 1 preferably comprises an actuator 10 configured to vibrate the sample holder 3, in a controlled manner, at a predetermined frequency. The actuator 10 may for example be a piezoelectric (or “dither”) actuator, configured to vibrate the sample holder 3 at its natural frequency. The actuator can also be of the acoustic type (it emits acoustic waves), of the mechanical type or of the magnetic type.

The actuator 10 can be fixedly mounted on the sample holder 3, for example supported by the second part 7 of the sample holder 3. The method according to one aspect of the invention can comprise a step, preferably simultaneous with the step of measuring the displacement of the first area 4, in which the actuator 10 is actuated so as to vibrate the first area 4 of the sample holder 3 at a predetermined frequency comprised between 500 Hz and 10 MHz. For a natural resonance frequency f₀ of the sample holder 3, the actuator 10 is preferably actuated so as to vibrate the first area 4 at a frequency comprised between f₀-0.5.f₀ and f₀+0.5.f₀, in particular comprised between f₀-0.1.f₀ and f₀+0.1.f₀. Thus, it is possible to measure a variation in the amplitude of the vibrations of the first area 4 or of the frequency of the vibrations of the first area 4 during an interaction between the surface 9 and the tip 13. The actuation of the first area 4 can also be implemented at several predetermined frequencies. It is thus possible to evaluate the behavior of a sample 2 under stress at different frequencies or speeds.

The device 1 can also comprise a closed-loop servo-control regulator 11. A signal representative of the displacement of the first area 4 can be transmitted by the detector 8 to the regulator 11. The regulator 11 can then transmit a regulation instruction to the actuator 10 and/or to the means for positioning the tip 13, so as to regulate the interactions between the tip 13 and the surface 9.

The device 1 preferably comprises an actuator for positioning the tip allowing to position the tip 13 of the probe 5 facing the surface 9. The tip positioning actuator can be a piezo motor. The regulator 11 can be configured to transmit a regulation signal to the tip positioning actuator, so as to maintain the tip 13 at a constant and predetermined distance from the surface 9 over time.

### Configurations of the Sample Holder 3

The Quality Factor (Defined by the Ratio Between the Resonance Frequency and the width of the Lorentzian resonance at mid-height) can be controlled by the shape of the sample holder 3 used. In particular, the sample holder 3 can have the shape of a beam fixedly mounted at its two ends to the support 6 by the second areas 7. The first area 4 is then arranged in the middle of the beam, at an equal distance from each of the second areas 7. Thus, the quality factor of the sample holder 3 can be maximized. The sample holder 3 can also have the shape of a membrane. In this case, the first area 4 is arranged at the center of the membrane, and the second area 7 is arranged at the edge of the membrane.

### Calibration of the Device 1

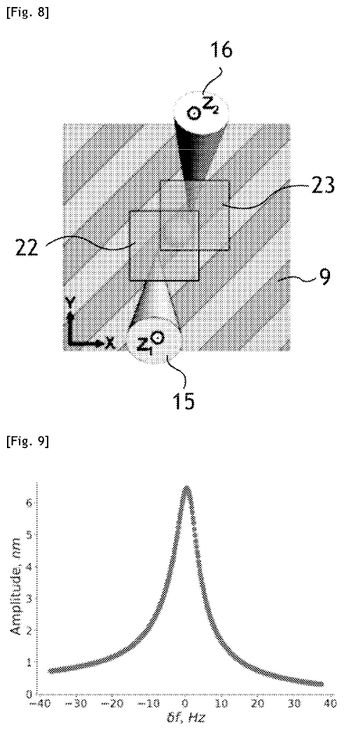

With reference to FIG. 8, another object of the invention is a method for determining a spatial calibration parameter of a device 1, comprising the first probe 15 and the second probe 16. The method comprising the steps of:
positioning the first probe 15 facing a first point of the surface 9,
measuring the displacement of the first area 4 relative to the second area 7 by the detector 8 so as to evaluate an interaction between the surface 9 and the first probe 15,
positioning the second probe 16 facing a second point of the surface 9,
measuring the displacement of the first area 4 relative to the second area 7 by the detector 8 so as to evaluate an interaction between the surface 9 and the second probe 16,
   the method comprising:
determining a first calibration image 22 of the surface 9 from a repetition of the steps of positioning the first probe 15 and measuring the displacement of the first area 4 relative to the second area 7 by the detector 8 so as to evaluate an interaction between the surface 9 and the first probe 15, each step of positioning the first probe 15 being implemented facing different first points of the surface 9,
determining a second calibration image 23 of the surface 9 from a repetition of the steps of positioning the second probe 16 and measuring the displacement of the first area 4 relative to the second area 7 by the detector 8 so as to evaluate an interaction between the surface 9 and the second probe 16, each step of positioning the second probe 16 facing a second point of the surface 9 being implemented facing different second points of the surface 9,
determining the spatial calibration parameter from a spatial offset between the first calibration image 22 and the second calibration image 23. Thus, it is possible to precisely determine the spatial offset between two probes 5, and preferably between the tip 13 of each of the probes 5, when each of the probes 5 is in a position for measuring or modifying the surface 9.

Preferably, the first calibration image 22 and the second calibration image 23 each have at least a part representative of the same part of the surface 9.

The alignment can be implemented digitally, by known image registration methods or known image matching methods, by a processing unit, the device 1 preferably comprising the processing unit.

The method for evaluating a surface described above preferably comprises a step of correcting the spatial position of a probe 5, preferably of the first probe 15 and/or of the second probe 16, in which the first probe 15 and/or the second probe 16 is spatially offset so as to compensate for the spatial offset between the first probe 15 and the second probe 16 by the predetermined spatial calibration parameter, preferably by the method for determining a spatial calibration parameter.

### Example

### Device Example 1

With reference to FIG. 9, the sample holder 3 can comprise a macroscopic aluminum beam, fixedly mounted on a support 6. The length L of the beam is equal to 7.5 cm, the width w of the beam is equal to 6.8 mm and the thickness t of the beam is equal to 12 mm. A spring constant k of the tuning fork formed by the beam is defined by the formula (1):

$$\begin{matrix}i . & \\ k = \frac{{Ewt}^{3}}{4 {L}^{3}} & ( 1 )\end{matrix}$$

in which E is the Young's modulus of aluminum, which allows to calculate k substantially equal to 100 kN/m. The resonance frequency of the fundamental mode of the beam is defined by the formula (2):

$$\begin{matrix}ii . & \\ {f}_{0} = \frac{\sqrt{k / {m}_{eff}}}{2 π} & ( 2 )\end{matrix}$$

where m_{eff} is the effective mass of the beam, equal to 0.24ρ×t×w×L, ρ being the density of aluminum. The frequency f₀ is substantially equal to 1 kHz, and m_{eff} is substantially equal to 3.8 g.

A piezoelectric actuator 10 is glued to the support 6 and allows the mechanical excitation of the sample holder 3. The oscillations of the sample holder 3 are detected using a Michelson interferometer, comprising a focused laser detection spot at the end of the sample holder 3. The sample 2 to be characterized is glued to the end of the sample holder 3 opposite the support 6, and on the side opposite the laser detection spot relative to the sample holder 3. FIG. 9 illustrates the mechanical response of the sample holder, forming an oscillator, and coupled to the sample of highly oriented pyrolytic graphite (HOPG). The amplitude of the oscillation as a function of the difference at the natural frequency has a standard Lorentzian shape with a quality factor of the order of 100.

The first probe 15 is a Pt-Ir STM tip, and the second probe 16 is a chemically etched tungsten tip. Each of the tips is placed on a three-axis piezo-scanner with sub-nanometric resolution (Tritor101 Piezosystemjena) and faces the surface of the sample. A voltage difference can be applied between one of the probes 5 and the surface 9 of the sample, so as to detect an electric current between the surface 9 and the probe 5, by a low noise amplifier.

The sensitivity Fₘᵢₙ to the strength of an oscillator in a certain frequency range B can be calculated by the formula (3):

$${F}_{min} = \sqrt{\frac{w {t}^{2}}{L Q}} {( E ρ )}^{1 / 4} {( {k}_{B} T )}^{1 / 2} \approx 100 pN / \sqrt{Hz} \qquad ( 3 )$$

wherein k_{B} is Boltzmann's constant, and T is equal to 300 K. By choosing a sample holder 3 with a higher quality factor, such as a tuning fork, this value can be decreased by more than one order of magnitude. However, the configuration according to this embodiment of the invention is compatible with near-field measurements.

### Example of Use

The device 1 is initially used as a scanning tunneling microscope (STM). The sample holder 3 is kept at rest and a constant electrical voltage is applied between the first Pt/It probe 15 and the sample 2. The first probe 15 is then moved closer to the surface 9 of the sample 2 while the electric current is recorded. Unlike a standard scanning tunneling microscope, the sample 2 is mounted on the end of an oscillator.

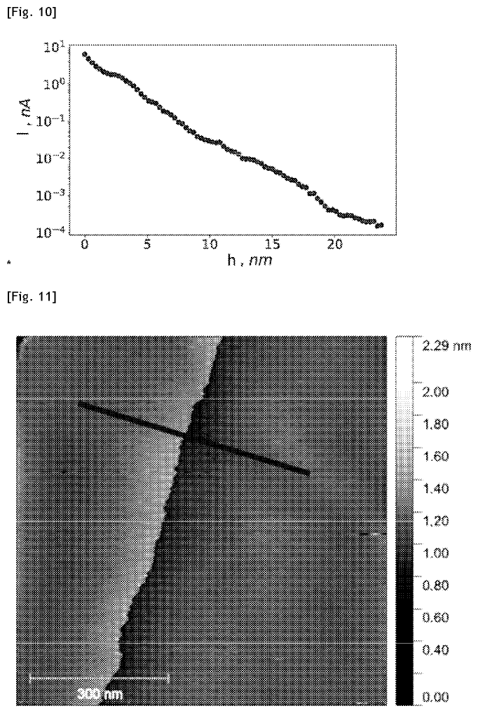

FIG. 10 illustrates an electronic current flowing between the first probe 15 and the surface 9 when a constant potential difference of 0.5 V is applied between the surface 9 and the tip of the first probe 15, according to the distance h between the surface 9 and the tip of the first probe 15, during the displacement of the first probe 15 towards the surface 9. The approach of the first probe 15 to the surface 9 leads to a strong increase in the detectable current. The noise level is sufficiently small to allow detection of a tunnel effect at distances h of the order of 1 nanometer.

A constant current regulation is imposed by the device 1, at a predetermined value. As with standard STM imaging, the probe 5 is then scanned over the surface and the distance h is adjusted to keep the measured current constant.

FIG. 11 illustrates an atomic step formed by the graphite surface and measured by the device 1 described above. FIG. 13 illustrates the profile measured according to the bar shown schematically in FIG. 11. The height of the step is measured equal to 0.6 nm, which corresponds to a two-layer atomic terrace.

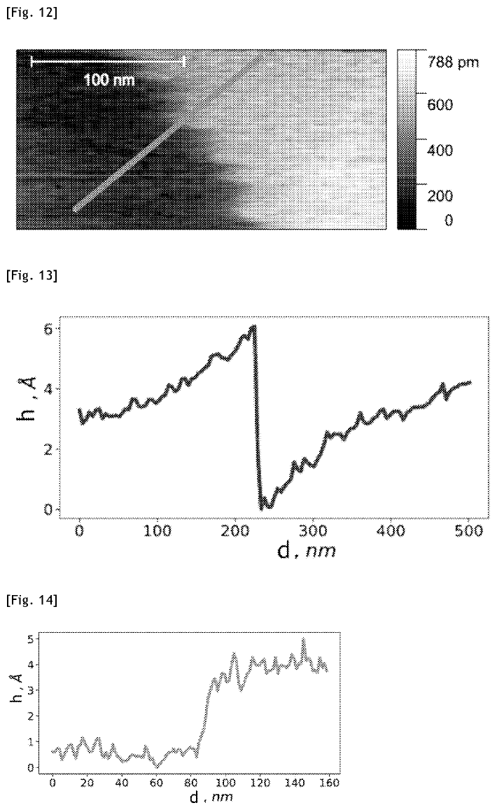

FIG. 12 illustrates an atomic step formed by the graphite surface and measured by the device 1 described above. FIG. 14 illustrates the profile measured according to the bar shown schematically in FIG. 12. The height of the step is measured equal to 0.3 nm, which corresponds to a single-layer atomic terrace.

A measurement of the AFM type can then be implemented. The sample holder 3, forming a mechanical oscillator, is excited at its resonant frequency. When the interaction of the oscillator with its environment is modified, a change in both frequency and amplitude is observed at the resonance. The variation in the resonance frequency δf is related to the conservative response of the force, while the widening of the resonance (variation from a quality factor Q₀ to another quality factor Q₁) is related to the dissipation.

Measurements and controls are carried out in real time by a complete set of Specs-Nanonis (RT5, SC5 and OC4). Two feedback loops allow to work at the resonance frequency of the sample holder 3 and to maintain the amplitude of oscillation A constant by modifying the amplitude of the voltage applied to the piezoelectric actuator 10. To produce AFM images, the device 1 is used in FM-AFM (Frequency Modulation AFM) mode. In this mode, the second probe 16 scans the surface 9 with a constant frequency offset, that is to say a constant force gradient. The amplitude of the vibration A of the oscillator is kept constant at 10 nm.

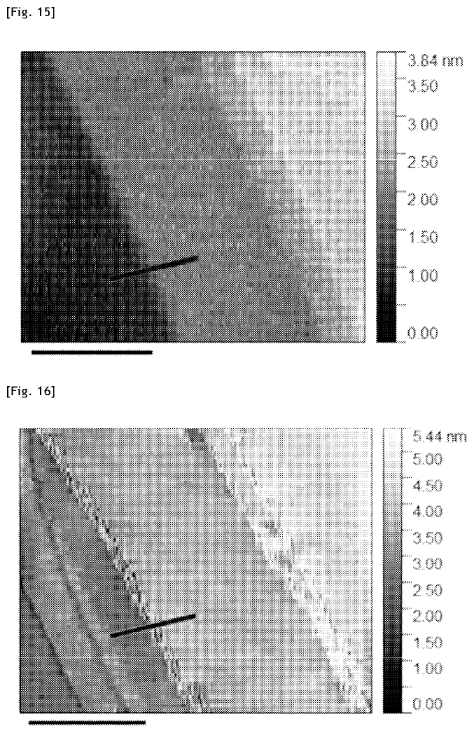

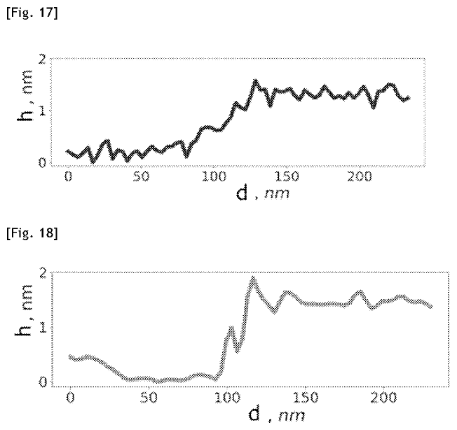

FIG. 15 illustrates an image obtained by scanning the second electrochemically etched tungsten probe 16 facing a graphite sample comprising a surface 9 characteristic of a HOPG. FIG. 17 illustrates the profile measured according to the bar shown schematically in FIG. 15.

An STM imaging can be performed on the same substrate by stopping the actuator 10. A constant electric voltage difference equal to 0.5 V is applied between the second probe 16 and the surface 9, and the electric current is measured. FIG. 16 illustrates an STM image measured by controlling a constant current. FIG. 18 illustrates a profile measured according to the bar shown schematically in FIG. 16.

The second probe 16 can also be considered as a hybrid probe 14 in this example: indeed, it allows both to measure a tunnel current and to carry out a force measurement. In this example, the device comprises a first probe 15 and a second probe 16, the second probe 16 being a hybrid probe used as an AFM probe or STM probe.

### Other Examples

In a first case, the device 1 can be used to implement containment measurements for a liquid. The device 1 then comprises a cell 12 into which a liquid to be studied is poured.

A first probe comprising a glass ball of a first diameter is used to measure the containment of the liquid.

A second probe comprising a glass ball with a second diameter different from the first diameter is used to also measure the containment of the liquid.

Optionally, a third probe comprising a glass ball of a third diameter different from the first diameter and the second diameter is used to also measure the confinement of the liquid.

The device 1 thus allows to measure the confinement of the liquid according to the diameter of the ball of the probe.

The balls used have a diameter which can vary between a few tens of microns and a few millimeters.

The use of different diameters allows to explore different rheological regimes.

The friction or confinement measurement carried out for each probe allows to analyze different rheological regimes of the liquid.

As a variant of this first case, the deposition of the liquid in the cell 12 can be preceded by an AFM topological measurement of the bottom of the cell 12. In this case, the device also comprises an AFM probe which is used to carry out this topological measurement.

In a second case, the device 1 can be used to implement the deposition of magnetic elements on a surface and the measurement of a magnetic property of the surface after this deposition.

A first probe comprising a pipette or any other deposition system is used to deposit magnetic particles on the surface.

A second probe comprising a special magnetic tip is used to measure a magnetic property of the surface after this deposition.

As a variant of this second case, the deposition of the magnetic elements can be preceded by an AFM topological measurement of the surface. In this case, the device also comprises an AFM probe which is used to perform this topological measurement.

1. A device for measuring or modifying a surface of a sample, the device comprising:
a support,
a sample holder, the sample holder comprising a first area and at least a second area, the first area being configured to receive the sample, the sample being fixedly mounted to the first area, the second area being distinct from the first area, the second area being fixed relative to the support, the sample holder being deformable so as to allow relative displacement of the first area relative to the second area,
a detector configured to detect a displacement of the first area relative to the second area,
at least one of a hybrid probe and a set of probes,
i) the hybrid probe being configured to detect a first parameter at a point of the surface when the hybrid probe faces the point, the hybrid probe being configured to generate a first measurement signal representative of the first parameter, the hybrid probe being configured to detect a second parameter at the point of the surface, the first parameter being different from the first parameter, the hybrid probe being configured to generate a second measurement signal representative of the second parameter, the first parameter being different from the second parameter,
ii) the set of probes comprising a first probe and a second probe, the first probe being different from the hybrid probe, the second probe being different from the hybrid probe, the set of probes being configured in a first configuration or a second configuration, so that
in the first configuration the first probe is configured to detect a first parameter at the point of the surface when the first probe faces the point, the first probe being configured to generate the first measurement signal representative of the first parameter, the second probe being configured to detect the second parameter at the point of the surface when the second probe faces the point, the second probe being configured to generate the second measurement signal representative of the second parameter,
and
in the second configuration, one of the first probe and the second probe is configured to modify a third parameter of the surface at the point of the surface,
the device comprising a displacer configured to position the hybrid probe or the first probe and the second probe facing a plurality of points of the surface, so that a plurality of first signals and a plurality of second signals are generated
by the hybrid probe when the hybrid probe is positioned successively facing each point of the plurality of points, or
by the first probe and by the second probe when the first probe and the second probe are each positioned successively facing each point of the plurality of points,
the device comprising a processing module configured to determine a property of the surface at of the surface based on the plurality of first signals and the plurality of second signals.

2. The device according to claim 1, wherein the first probe and the second probe are each configured to modify respectively the third parameter of the surface and a fourth parameter of the surface at the point of the surface, the third parameter and the fourth parameter being different from each other.

3. The device according to claim 1, comprising the set of probes, the device also comprising a probe switch, the first probe and the second probe each being fixedly mounted on the probe switch, the switch being configured to cause movement of the first probe and the second probe relative to the sample holder, so that when the first probe faces dot of the surface and the switch causes movement, the second probe is moved so as to face the dot.

4. The device according to claim 1, comprising a cell configured to contain a liquid medium, the cell being preferably mounted fixed relative to the first area, and the sample being mounted fixed to the cell.

5. The device according to claim 3, wherein the switch comprises a system for rotating the probes configured so that the movement is a rotational movement, the switch preferably comprising a translation system configured to control a translation of the rotation system, relative to the sample holder along an axis perpendicular to the surface.

6. The device according to claim 1, wherein the sample holder is a harmonic oscillator.

7. The device according to claim 1, comprising an actuator configured to vibrate the sample holder at a predetermined frequency.

8. The device according to claim 1, comprising a closed-loop servo-control regulator, the detector being configured to transmit a signal representative of a measurement of the displacement of the first area to the regulator and the regulator being configured to transmit a regulation signal to the actuator.

9. The device according to claim 1, comprising a cell configured to contain a liquid medium, the cell being preferably mounted fixed relative to the first area, and the sample being mounted fixed to the cell.

10. A method for evaluating a surface of a sample by a device according to claim 1, the device comprising the set of probes,
the method comprising steps of:
a) positioning the first probe facing a point of the surface,
b) measuring the displacement of the first area relative to the second area by the detector so as to evaluate an interaction between the surface and the first probe,
c) positioning the second probe facing the point of the surface, and
d) measuring the displacement of the first area relative to the second area by the detector so as to evaluate an interaction between the surface and the second probe.

11. The method according to claim 10, wherein one of the first probe and the second probe is configured to modify a third parameter of the surface at the point of the surface, the method comprising a step, subsequent to step b) and/or to step d), of modifying the third parameter of the surface at the point of the surface.

12. The method according to claim 10, wherein a repetition of step a) defines a scanning of the surface by the first probe.

13. The method according to claim 10, comprising the steps of:
determining a first image of the surface from a repetition of step b), each step b) being subsequent to a step a) of the repetition of steps a),
determining a second image of the surface from a repetition of step d), each step d) being subsequent to a step c) of the repetition of steps c), and preferably a step of
determining a third image of the surface from the first image and the second image.

14. The method according to claim 10, also comprising a step e) of actuating the sample holder, concomitant with the measurement step b) and/or with the measurement step d), in which the actuator is actuated so as to vibrate the first area of the sample holder at a predetermined frequency comprised between 500 Hz and 10 MHz.

15. The method for determining a spatial parameter for calibrating a device for measuring and/or modifying a surface of a sample, the device being a device according to claim 1, comprising the set of probes,
the method comprising steps of:
e) positioning the first probe facing a first point of the surface,
f) measuring the displacement of the first area relative to the second area by the detector so as to evaluate an interaction between the surface and the first probe,
g) positioning the second probe facing a second point of the surface,
h) measuring the displacement of the first area relative to the second area by the detector so as to evaluate an interaction between the surface and the second probe,
the method comprising:
determining a first calibration image of the surface from a repetition of steps e) and f), each step e) being implemented facing different first points of the surface,
determining a second calibration image of the surface from a repetition of steps g) and h), each step g) being implemented facing different second points of the surface,
determining the spatial calibration parameter from a spatial offset between the first calibration image and the second calibration image.

16. The method according to claim 10, wherein step a) is realized so that the first probe is positioned facing the point of the surface at a distance less than 100 nm from the point of the surface.

17. The method according to claim 16, wherein the distance is less than 10 nm from the point of the surface.

18. The method according to claim 10, wherein step c) is realized so that the second probe is positioned facing the point of the surface at a distance less than 100 nm from the point of the surface.

19. The method according to claim 18, wherein the distance is less than 10 nm from the point of the surface.

20. The method according to claim 12, wherein a repetition of step c) defines the same scanning of the surface by the second probe.

21. The method according to claim 14, wherein the sample holder has at least one natural resonance frequency fₖ, so as to vibrate the first area at a frequency comprised between (fₖ−0.5.fₖ) and (fₖ+0.5.fₖ).
